(19) United States
(12) Patent Application Publication
(10) Pub. No.: US 2005/0050179 A1
(43) Pub. Date: Mar. 3, 2005

(54) Method, apparatus and computer program product for implementing enhanced proxy ARP for virtual IP addresses

(75) Inventors: Gary A. Diehl, Endicott, NY (US); Franklin A. Gruber, Vestal, NY (US); Daniel A. Vega, Oronoco, MN (US)

Correspondence Address: Grant A. Johnson;IBM Corporation-Dept. 917, 3605 Highway 52 North, Rochester, MN, 55901, US

(73) Assignee: INTERNATIONAL BUSINESS MACHINES CORPORATION, ARMONK, NY (US)

(21) Appl. No.: 10/650,538

(22) Filed: Aug. 28, 2003

(51) Int. Cl. G06F 15/177; G06F 15/16

(52) U.S. Cl. 709/221; 709/219

(57) ABSTRACT

A method, apparatus and computer program product are provided for implementing enhanced proxy Address Resolution Protocol (ARP) for Virtual Internet protocol (IP) addresses. A Virtual Internet protocol (IP) interface requiring proxy ARP is identified and a proxy agent for the Virtual Internet protocol (IP) interface is dynamically selected. An IP address for the Virtual Internet protocol (IP) interface is added to an address list of a physical adapter for the selected proxy agent. Utilizing the physical adapter for the selected proxy agent, the added IP address for the Virtual Internet protocol (IP) interface is broadcast with a media access control (MAC) address of the physical adapter for the selected proxy agent.

### FIELD OF THE INVENTION

The present invention relates generally to the data processing field, and more particularly, relates to a method, apparatus and computer program product for implementing enhanced proxy Address Resolution Protocol (ARP) for Virtual Internet protocol (IP) addresses.

### DESCRIPTION OF THE RELATED ART

Address Resolution Protocol (ARP) is a protocol used to determine the hardware or media access control (MAC) addresses of machines on a network. Internet Protocol (IP) is a connectionless protocol. IP packets are routed from an originator through a network of routers to the destination. An IP Address that is unique within the network and identifies all physical adapter devices in such a network, including those for client and server hosts. One valuable feature of IP is that a failure of an intermediate router node or adapter will not prevent a packet from moving from source to destination, as long as there is an alternate path through the network.

In Transmission Control Protocol/Internet Protocol (TCP/IP), TCP sets up a connection between two endpoints, identified by the respective IP addresses and a port number on each. If an endpoint adapter fails, all connections through that adapter fail. If the failure is on a client workstation host, only the relatively few client connections are disrupted, and usually only one person is inconvenienced. However, an adapter failure on a large capacity server can cause a very large number of connections to be disrupted.

To alleviate this situation, International Business Machines Corporation introduced a Virtual IP Address (VIPA) on a server TCP/IP that has been used on some server computers, such as an eServer iSeries® server manufactured and sold by International Business Machines Corporation. A VIPA is configured generally the same as a normal IP address for a physical adapter, except that it is not associated with any particular device. To an attached router, the TCP stack on the server computer looks like another router. When the TCP stack receives a packet destined for one of its VIPAs, the inbound IP function of the TCP stack notes that the IP address of the packet is in the TCP stack's home list of IP addresses and forwards the packet up the TCP stack. The home list of a TCP stack is the list of IP addresses that are owned by the TCP stack. Assuming the TCP stack has multiple adapters or paths to it, if a particular physical adapter fails, the attached routing network will route VIPA-targeted packets to the TCP stack via an alternate route. The VIPA may, thus, be thought of as an address to the stack, and not to any particular adapter.

Thus, Virtual IP defines an IP address for the system that is not bound to any one physical adapter. Virtual IP was originally introduced for load balancing but it can also be used to provide fault tolerance across a local adapter failure. If remote clients, or the Dynamic Name Server (DNS) interrogated by the remote clients, only know the iSeries server by its Virtual IP address, and the local gateways know the paths to reach the Virtual IP address, the system will stay accessible so long as at least one physical interface is active. This provides enhanced system availability for customers, a feature being requested more and more, as the capacity of the iSeries servers continue to increase.

However, a problem remains because the Virtual IP addresses are not directly routable. That is why the local gateways or routers needed explicit routes configured in order to forward packets to the Virtual IP interface. On the plus side, this allows the same Virtual IP address to be configured on multiple machines. This is commonly done for high availability web serving with multiple CPUs. But, the downside is the iSeries server will never answer an ARP request destined to Virtual IP address. Configuring these same additional explicit routes configured in order to forward packets to the Virtual IP interface in each locally attached client is cumbersome at best, and impractical at worst. The local clients could be configured to send all of their data to the routers, but that just adds unnecessary traffic to the router. Or the local clients could access the iSeries server using one of the physical IP addresses, but if the adapter on which that IP address is defined goes down, the iSeries server appears down to the client. The net result that, for locally attached clients, the fault tolerance, high availability advantages of Virtual IP are not available.

A need exists for a mechanism that effectively enables the fault tolerance, high availability advantages of Virtual IP for locally attached clients.

### SUMMARY OF THE INVENTION

The present invention provides a method, apparatus and computer program product for implementing enhanced proxy Address Resolution Protocol (ARP) for Virtual Internet protocol (IP) addresses. Other important aspects of the present invention are to provide a method, apparatus and computer program product for implementing enhanced proxy Address Resolution Protocol (ARP) for Virtual Internet protocol (IP) addresses substantially without negative effect and that overcome many of the disadvantages of prior art arrangements.

In brief, a method, apparatus and computer program product are provided for implementing enhanced proxy Address Resolution Protocol (ARP) for Virtual Internet protocol (IP) addresses. A Virtual Internet protocol (IP) interface requiring proxy ARP is identified and a proxy agent for the Virtual Internet protocol (IP) interface is dynamically selected. An IP address for the Virtual Internet protocol (IP) interface is added to an address list of a physical adapter for the selected proxy agent. Utilizing the physical adapter for the selected proxy agent, the added IP address for the Virtual Internet protocol (IP) interface is broadcast with a media access control (MAC) address of the physical adapter for the selected proxy agent.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram illustrating a server computer and network computing system for implementing enhanced proxy Address Resolution Protocol (ARP) methods for Virtual Internet protocol (IP) addresses in accordance with the preferred embodiment;

FIG. 2 is a flow chart illustrating a proxy ARP for Virtual IP interface initiation task in accordance with the preferred embodiment;

FIG. 3 is a flow chart illustrating an IOP response handier task in accordance with the preferred embodiment; and

FIG. 4 is a block diagram illustrating a computer program product in accordance with the preferred embodiment.

### DETAILED DESCRIPTION OF THE PREFERRED EMBODIMENTS

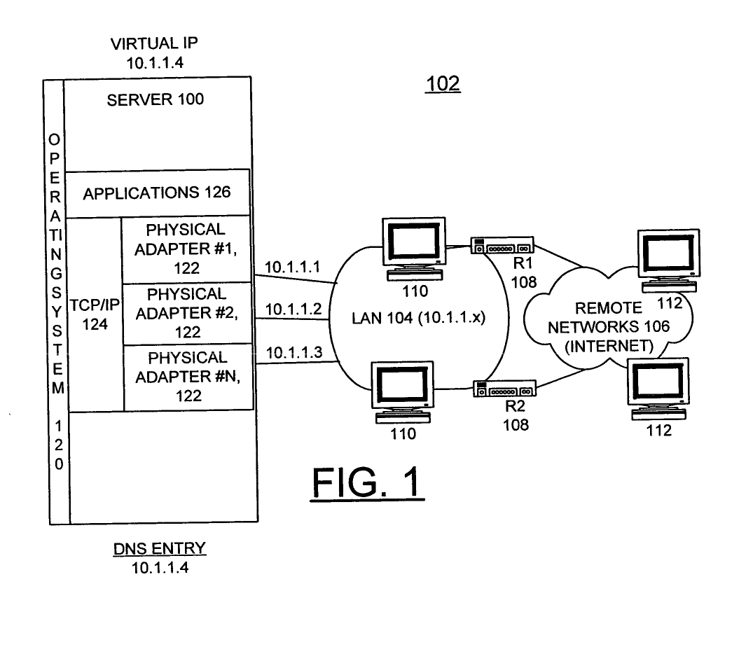

Having reference now to the drawings, in FIG. 1, there is shown a server computer generally designated by the reference character 100 in a network computing system generally designated by the reference character 102 for implementing methods for enhanced proxy APR for Virtual IP addresses in accordance with the preferred embodiment. Network computing system 102 includes a local area network (LAN) 104 coupled to the server computer 100 and to a plurality of remote networks 106, such as the Internet 106, by a pair of routers R1 and R2, 108. A plurality of local clients 110 is coupled to the server computer 100 via LAN 104. A plurality of remote clients 112 is coupled to the server computer 100 via remote network 106, a respective one of routers R1 and R2, 108, and LAN 104. As shown, LAN 104 has a network number or address of 10.1.1.x.

Server computer 100 includes an operating system 120, a plurality of adapters #1−N, 122 (three shown) connecting the server to the local 10.1.1.x network 104, a TCP/IP code or stack 124 of the preferred embodiment, and applications 126.

Server computer 100 together with network computing system 102 is shown in simplified form sufficient for understanding the present invention. The illustrated server computer 100 and network computing system 102 are not intended to imply architectural or functional limitations. The present invention can be used with various hardware implementations and network systems.

Various commercially available computers can be used for server computer 100; for example, an iSeries server manufactured and sold by International Business Machines Corporation.

Remote clients 112 know the server 100 by the Virtual IP address of 10.1.1.4. Each of the routers R1 and R2, 108 have three routes configured to the virtual IP address, with respective next hop gateway addresses of 10.1.1.1, 10.1.1.2, and 10.1.1.3 as shown in FIG. 1 for the illustrated three adapters 122. So long as at least one of the three adapters 122 is active, the server 100 remains accessible to remote clients 112.

In accordance with features of this embodiment, to extend this method of fault tolerance to locally attached clients 110, a new support feature is added to server computer 100 to allow Virtual IP addresses to be configured as directly routable. This directly routable configuration allows the iSeries server 100 to answer ARP requests, that is, to Proxy ARP, for Virtual IP addresses. Proxy ARP for Virtual IP interfaces provides customers with an increased fault tolerance, and higher system availability. A new “Proxy ARP Yes/No” option is presented when a Virtual IP interface is configured. This option defaults off to prevent existing configurations from breaking upon upgrading the new support feature in accordance with this embodiment. When this new enhanced Proxy ARP option is enabled, the Transmission Control Protocol/Internet Protocol (TCP/IP) code 124 answers ARP requests to the Virtual IP address (VIPA).

Conventional Proxy ARP supported on the other interface types, such as point-to-point protocol (PPP) interface, twinaxial data link control protocol (TDLC) interface, OptiConnect (OPC) serial optical bus interface and Virtual Ethernet interface answers ARP requests, but has an important difference between this use of new enhanced Proxy ARP this embodiment. In all other cases, when an interface is configured such that its IP address should be proxied for, an additional parameter must also be coded, that is the Associated Local Interface must also be coded. Normally, the Associated Local Interface specifies which interface should act as the Proxy Agent, that is, which interface should answer the incoming ARP requests on behalf of the proxy client.

In accordance with features of this embodiment, when Proxy ARP is selected for a Virtual IP interface, no Associated Local Interface is specified. Instead, the proxy agent is dynamically selected by the TCP/IP stack code. One reason for dynamically selecting the proxy agent by the TCP/IP stack code is so the proxy agent interface can be dynamic. If the interface that is currently acting as the proxy agent for a Virtual IP interface goes down, the agent function is immediately moved to an alternate interface, if one exists, so that the Virtual IP address remains accessible to local and remote clients.

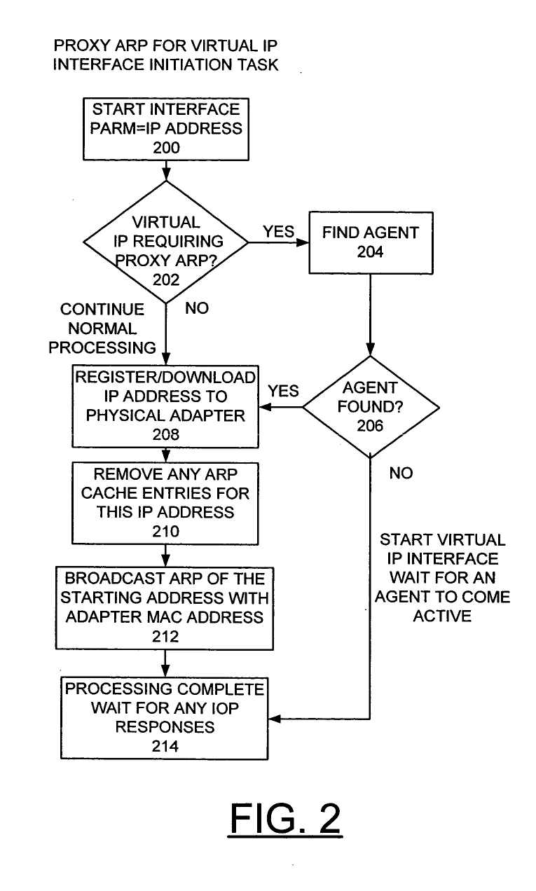

Referring now to FIG. 2, there are shown exemplary steps of a Proxy ARP for Virtual IP interface initiation task in accordance with the preferred embodiment. As indicated in a block 200, the sequential steps begin with a start interface parameter is set to IP address. Checking to determine if Virtual IP requiring proxy ARP is enabled as indicated in a decision block 202. When the Virtual IP interface is started and is configured for proxy ARP, the routine scans the system automatically searching all the configured interfaces for a suitable agent interface as indicated in a block 204. The agent interface must be in the same subnet as the Virtual IP interface. When an agent is not found as indicated in a decision block 206, then the Virtual IP interface or VIPA will go active and wait for a suitable interface to be started.

When an agent is found as indicated at decision block 206, then the VIPA's IP address must now be added to the adapter's address list. A message is built with the new IP address that the selected physical adapter 122 must add to its address list to register or download the VIPA's IP address to the physical adapter 122 as indicated in a block 208. The adapter's address list contains all the IP addresses for which the adapter 122 will send and receive data.

Next a message is built which instructs the adapter 122 to remove any existing ARP cache entries for the VIPA's IP address from the adapter's ARP cache as indicated in a block 210. A message is built which instructs the selected adapter 122 to broadcast the new or starting IP address that has become active with its agent MAC address as indicated in a block 212. All clients 110, routers R1 and R2, 108, and the like on network 102 will receive the broadcast and will update their ARP entries with this new address. As indicated in a block 214, processing is complete for now and waiting for the adapter 122 to send acknowledgments to any input/output processor (IOP) responses is performed.

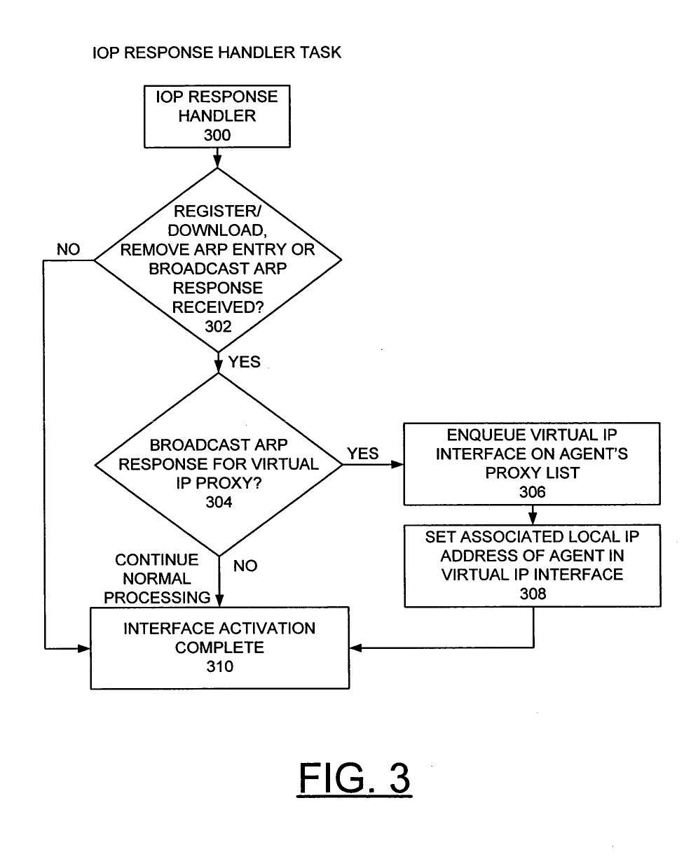

Referring now to FIG. 3, there are shown exemplary steps of an IOP response handler task in accordance with the preferred embodiment starting at a block 300. First verifying that a received response is a Register/Download, Remove ARP entry, or broadcast ARP response is performed as indicated in a decision block 302. Checking if the received response is a broadcast ARP response for virtual IP proxy is performed as indicated in a decision block 304. If so, the rest of the activation for the VIPA is continued. The virtual IP interface is enqueued on the agent's proxy list as indicated in a block 306. The agent's proxy list contains all the interfaces for which this agent interface is proxying. The agent interface's IP address is then set in VIPA as the associated local interface as indicated in a block 308. This is the interface that is acting as a proxy agent. Interface activation is now complete as indicated in a block 310.

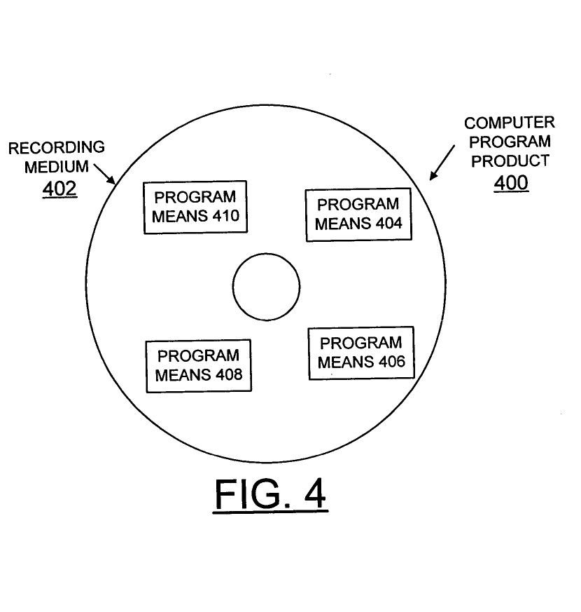

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing enhanced proxy Address Resolution Protocol (ARP) for Virtual Internet protocol (IP) addresses of the preferred embodiment in the server 100 of FIG. 1.

A sequence of program instructions or a logical assembly of one or more interrelated modules defined by the recorded program means 404, 406, 408, 410, direct the server computer 100 for implementing enhanced proxy Address Resolution Protocol (ARP) for Virtual Internet protocol (IP) addresses of the preferred embodiment.

While the present invention has been described with reference to the details of the embodiments of the invention shown in the drawing, these details are not intended to limit the scope of the invention as claimed in the appended claims.

1. A method for implementing enhanced proxy Address Resolution Protocol (ARP) for Virtual Internet protocol (IP) addresses comprising:
identifying a Virtual Internet protocol (IP) interface requiring proxy ARP;
dynamically selecting a proxy agent for said Virtual Internet protocol (IP) interface;
adding an IP address for said Virtual Internet protocol (IP) interface to an address list of a physical adapter for said selected proxy agent;
utilizing said physical adapter for said selected proxy agent, and broadcasting said added IP address for said Virtual Internet protocol (IP) interface with a media access control (MAC) address of said physical adapter for said selected proxy agent.

2. A method for implementing enhanced proxy Address Resolution Protocol (ARP) for Virtual Internet protocol (IP) addresses as recited in claim 1 further includes identifying a broadcast ARP response for said Virtual Internet protocol (IP) interface, and continuing activation for said Virtual Internet protocol (IP) interface including enqueuing said Virtual Internet protocol (IP) interface to a proxy list of said selected proxy agent.

3. A method for implementing enhanced proxy Address Resolution Protocol (ARP) for Virtual Internet protocol (IP) addresses as recited in claim 1 further includes setting an associated local IP address of said selected proxy agent in said Virtual Internet protocol (IP) interface.

4. A method for implementing enhanced proxy Address Resolution Protocol (ARP) for Virtual Internet protocol (IP) addresses as recited in claim 1 wherein the step of dynamically selecting said proxy agent for said Virtual Internet protocol (IP) interface includes providing Transmission Control Protocol/Internet Protocol (TCP/IP) code for dynamically selecting said proxy agent.

5. A method for implementing enhanced proxy Address Resolution Protocol (ARP) for Virtual Internet protocol (IP) addresses as recited in claim 1 wherein said selected proxy agent fails; and a new proxy agent is dynamically selected for said Virtual Internet protocol (IP) interface by Transmission Control Protocol/Internet Protocol (TCP/IP) code.

6. A method for implementing enhanced proxy Address Resolution Protocol (ARP) for Virtual Internet protocol (IP) addresses as recited in claim 1 wherein the step of dynamically selecting said proxy agent for said Virtual Internet protocol (IP) interface includes checking for a proxy agent in the same subnet as said Virtual Internet protocol (IP) interface.

7. A method for implementing enhanced proxy Address Resolution Protocol (ARP) for Virtual Internet protocol (IP) addresses as recited in claim 1 further includes answering ARP requests for Virtual Internet protocol (IP) addresses with Transmission Control Protocol/Internet Protocol (TCP/IP) code for said selected proxy agent for said Virtual Internet protocol (IP) interface.

8. Apparatus for implementing enhanced proxy Address Resolution Protocol (ARP) for Virtual Internet protocol (IP) addresses comprising:
a local network;
a server computer having a Virtual Internet protocol (IP) address and a plurality of physical adapters connecting said server computer to said local network,
a Transmission Control Protocol/Internet Protocol (TCP/IP) code for dynamically selecting a proxy agent for said Virtual Internet protocol (IP) interface;
a proxy ARP for Virtual IP interface initiation task for adding an IP address for said Virtual Internet protocol (IP) interface to an address list of an associated one of said physical adapters for said selected proxy agent; and for utilizing said physical adapter for said selected proxy agent for broadcasting said added IP address for said Virtual Internet protocol (IP) interface with a media access control (MAC) address of said physical adapter for said selected proxy agent.

9. Apparatus for implementing enhanced proxy Address Resolution Protocol (ARP) as recited in claim 8 wherein said TCP/IP code is responsive to a failure of said physical adapter for said selected proxy agent, for dynamically selecting a new proxy agent for said Virtual Internet protocol (IP) interface.

10. Apparatus for implementing enhanced proxy Address Resolution Protocol (ARP) as recited in claim 8 wherein said TCP/IP code answers ARP requests to said Virtual Internet protocol (IP) address; said ARP requests being provided without a parameter defining an associated local interface being specified with said ARP requests to said Virtual Internet protocol (IP) address.

11. Apparatus for implementing enhanced proxy Address Resolution Protocol (ARP) as recited in claim 8 includes a input/output processor (IOP) response handler task for identifying a broadcast ARP response for said Virtual Internet protocol (IP) interface, and for continuing activation for said Virtual Internet protocol (IP) interface including enqueuing said Virtual Internet protocol (IP) interface to a proxy list of said selected proxy agent.

12. Apparatus for implementing enhanced proxy Address Resolution Protocol (ARP) as recited in claim 11 wherein said IOP response handier task is adapted for setting an associated local IP address of said selected proxy agent in said Virtual Internet protocol (IP) interface to complete activation for said Virtual Internet protocol (IP) interface.

13. A computer program product for implementing enhanced proxy Address Resolution Protocol (ARP) for Virtual Internet protocol (IP) addresses in a server computer, said computer program product including instructions executed by the server computer to cause the server computer to perform the steps of:
identifying a Virtual Internet protocol (IP) interface requiring proxy ARP;
dynamically selecting a proxy agent for said Virtual Internet protocol (IP) interface;
adding an IP address for said Virtual Internet protocol (IP) interface to an address list of a physical adapter for said selected proxy agent;
utilizing said physical adapter for said selected proxy agent, and broadcasting said added IP address for said Virtual Internet protocol (IP) interface with a media access control (MAC) address of said physical adapter for said selected proxy agent.

14. A computer program product for implementing enhanced proxy Address Resolution Protocol (ARP) for Virtual Internet protocol (IP) addresses as recited in claim 13 further includes the step of identifying a broadcast ARP response for said Virtual Internet protocol (IP) interface, and continuing activation for said Virtual Internet protocol (IP) interface including enqueuing said Virtual Internet protocol (IP) interface to a proxy list of said selected proxy agent.

15. A computer program product for implementing enhanced proxy Address Resolution Protocol (ARP) for Virtual Internet protocol (IP) addresses as recited in claim 14 further includes the step of setting an associated local IP address of said selected proxy agent in said Virtual Internet protocol (IP) interface to complete activation for said Virtual Internet protocol (IP) interface.

16. A computer program product for implementing enhanced proxy Address Resolution Protocol (ARP) for Virtual Internet protocol (IP) addresses as recited in claim 13 wherein Transmission Control Protocol/Internet Protocol (TCP/IP) code is used for the step of dynamically selecting said proxy agent for said Virtual Internet protocol (IP) interface.

17. A computer program product for implementing enhanced proxy Address Resolution Protocol (ARP) for Virtual Internet protocol (IP) addresses as recited in claim 16 wherein said Transmission Control Protocol/Internet Protocol (TCP/IP) code is responsive to a failure of said physical adapter for said selected proxy agent, for dynamically selecting a new proxy agent for said Virtual Internet protocol (IP) interface.

18. A computer program product for implementing enhanced proxy Address Resolution Protocol (ARP) for Virtual Internet protocol (IP) addresses as recited in claim 16 wherein said Transmission Control Protocol/Internet Protocol (TCP/IP) code utilizes said physical adapter for said selected proxy agent for answering ARP requests to said Virtual Internet protocol (IP) address; said ARP requests being provided without a parameter defining an associated local interface being specified with said ARP requests to said Virtual Internet protocol (IP) address.
